(19) United States
(12) Patent Application Publication
(10) Pub. No.: US 2004/0022389 A1
(43) Pub. Date: Feb. 5, 2004

(54) Non-standard coding systems

(76) Inventors: Chaim Shen-Orr, Haifa (IL); Colin John Davies, Fordingbridge (GB); Yossi Tsuria, Jerusalem (IL)

Correspondence Address: Welsh & Katz Ltd, 22nd Floor, 120 South Riverside Plaza, Chicago, IL, 60606-3913, US

(21) Appl. No.: 10/344,656

(22) PCT Filed: Aug. 28, 2001
(86) PCT No.: PCT/IL01/00801

(30) Foreign Application Priority Data
Aug. 22, 2001 (GB) 0120442.9

(51) Int. Cl. H04N 7/167

(52) U.S. Cl. 380/210

(57) ABSTRACT

A method for transforming content from a standard form coded in accordance with a standard coding scheme to content in a non-standard form coded in accordance with a non-standard coding scheme. The method includes providing content coded in a standard form in accordance with a standard coding scheme, the standard coding scheme including at least one syntax element; and altering the content coded in the standard form in accordance with a non-standard syntax modification scheme, thereby producing content encoded in a non-standard form in accordance with a non-standard coding scheme. Related apparatus and methods are also provided.

### FIELD OF THE INVENTION

The present invention relates to coding and compression schemes in general, and in particular to multimedia content coding and compression schemes.

### BACKGROUND OF THE INVENTION

It is well known in the art that a large quantity of data is required to represent rich multimedia content, such as video, audio, and combinations of audio and video, in a raw digital form.

To aid the distribution and storage of digital multimedia content, compression, in accordance with a compression algorithm, is typically used in the prior art to reduce the data size. Most compression algorithms in common use are termed “lossy” compression algorithms. Lossy compression algorithms remove information from the content, such that the reconstructed content, after compression and decompression, is not a perfect copy of the original.

Most multimedia compression algorithms for video and audio can be considered as comprising the following steps:

1. Convert the analog signal to a digital signal, with suitable sampling frequency, resolution and accuracy.

2. Represent the content as a set of transformed primitives. For still images this might be discrete cosine transform (DCT) blocks as in JPEG. For audio this might the output of a set of filter banks. For video this might be a combination of DCT blocks and motion estimation vectors.

3. Perform a lossy step on the transformed data. For images and video the lossy step might comprise simple quantization of the DCT transformed coefficients. For audio the lossy step might comprise quantization of the outputs of the filter banks. In general this lossy step is designed to be imperceptible to the viewer/listener and involves a transformation carried out in accordance with a model of the human visual and audio systems. For high compression ratios it is known in the art that this step will introduce noticeable artefacts to the content; the aim is to make the artefacts as unintrusive as possible.

4. Syntactically code the resulting data. This step utilizes information theory to efficiently represent the data, often using variable length coding techniques. The syntax will also include synchronization markers for error resilience, random access and so forth, as well as data indicating the actual choice of conversion parameters, resolution and so forth.

Most multimedia encoding standards specify the syntax of the bit stream output by the compression algorithm and the function of the decoder. The encoding process itself is not standardized, but is merely required to produce a compliant bit stream. Hence there is scope for competition between different vendors in terms of the quality of coding performed.

The terms “compress” and “encode”, in all of their grammatical forms, are used interchangeably throughout the present specification and claims to refer to encoding algorithms such as those described above.

The following references describe multimedia coding standards and are believed to represent the state of the art:

ISO/IEC 10918 Information technology. Digital compression and coding of continuous-tone still images.

ISO/IEC 11172-2 Information technology. Coding of moving pictures and associated audio for digital storage media at up to about 1.5 Mbit/s. Video.

ISO/IEC 11172-3 Information technology. Coding of moving pictures and associated audio for digital storage media at up to about 1.5 Mbit/s. Audio.

ISO/IEC 13818-2 Information technology. Generic coding of moving pictures and associated audio information. Video.

ISO/IEC 13818-3 Information technology. Generic coding of moving pictures and associated audio information. Audio.

In the case of valuable content, such as valuable multimedia content, additional considerations apply.

FIG. 1 is a simplified block diagram illustration of a system for distributing valuable multimedia content in accordance with the prior art.

At a distribution headend 100 content, shown in FIG. 1 by way of example only as video content, is compressed (encoded) using a standard compression encoder 110. In the example of FIG. 1 the standard compression encoder 110 may comprise an encoder conforming to any appropriate standard. Examples of appropriate standards include international standard such as MPEG-1, MPEG-2, MPEG-4 and H.263. Other examples of appropriate standards include widely available proprietary standard such those as utilized by Windows Media or Real Networks.

For secure distribution, as would typically be used with valuable content, the content is then typically scrambled by a scrambler 120. It is intended in systems of this type that clients with the appropriate rights are able to descramble and view/render the content; those without such rights can not. An example of a client 130, including a descrambler and a standard decoder 150, is shown in FIG. 1. For sake of simplicity of description, only one client 130 is shown, it being appreciated that in practice a plurality or a large multiplicity of clients are used. Further for sake of simplicity of description, a rights management system is not shown in FIG. 1; any appropriate rights management system may be used.

Many appropriate systems for scrambling and for rights management are well known in the art. Well known prior art scrambling systems include DVB (Digital Video Broadcasting), which is described in the following reference:

ETSI ETR 289 Digital Video Broadcasting (DVB); Support for use of scrambling and Conditional Access (CA) within digital broadcasting systems.

Well known prior art rights management systems are generally proprietary.

In a case where the client 130 comprises software running on an open platform, such as a personal computer (PC) or a similar device, there is believed to be a real possibility of an unscrupulous user, also known as a “hacker”, attempting to steal the content. It is appreciated that a more sophisticated hacker may also be able to similarly attempt to steal the content even in a less open system.

In the prior art system of FIG. 1 an obvious place to attempt to steal the content is at a point indicated by reference number 160, where the encoded content is passed, in non-scrambled form, between the descrambler 140 and the standard decoder 150. If the encoded content is captured at point 160 it can be easily distributed to every person that has a suitable standard decoder. It is believed to be particularly desirable for an unscrupulous user to capture the encoded content at point 160 because the content is in non-scrambled yet compressed form; capturing the content in the decompressed form entails re-compressing it to a manageable, size, with attendant loss of quality due to the extra compression.

U.S. Provisional Patent Application Ser. No. 60/229,508, filed Aug. 31, 2001, is hereby incorporated herein by reference.

The disclosures of all references mentioned above and throughout the present specification are hereby incorporated herein by reference.

### SUMMARY OF THE INVENTION

The present invention seeks to provide improved apparatus and methods for protecting encoded content.

Throughout the present specification and claims, the term “content”, in all of its grammatical forms, is used to refer to digital content of any appropriate kind, including, but not limited to, any one or combination of the following: audio content; video content; and content intended for interpretation or execution by a computer or similar device. It is appreciated that rich digital multimedia content, as described above, is a particular type of content; the term “content”, as used throughout the present specification and claims, is not limited to rich digital multimedia content. It is further appreciated that the present invention, in certain preferred embodiments thereof, may be particularly useful when used with rich digital multimedia content.

It is believed that the aim of security mechanisms protecting content should be to make the task of stealing the content at any stage as difficult as possible. It is further believed that protecting non-scrambled encoded content, said content being described above with reference to prior art FIG. 1, is an important part of the task of making stealing content as difficult as possible. It is a goal of the present invention, in some preferred embodiments thereof, to improve security mechanisms protecting content.

A solution to counter the specific problem identified above with reference to FIG. 1, of stealing non-scrambled encoded content within the client 130 of FIG. 1, is for content to never appear in a standard compressed form within a client; this solution is achieved, in preferred embodiments of the present invention, by delivering the content in a non-standard bit stream to a non-standard decoder.

It is believed that even non-standard decoders are subject to hacker attacks through reverse engineering, and that it is virtually impossible to prevent such attacks when applied to software running on open platforms; successful reverse engineering is believed to be only a question of time.

In some preferred embodiments of the present invention, reverse engineering may be thwarted by varying the non-standard decoder every so often. Potentially, the non-standard decoder may be varied for each content item and/or for each user. In other words, if there are c content items and u users, there may potentially be up to c times u different non-standard decoders.

There is thus provided in accordance with a preferred embodiment of the present invention a method for producing a non-standard coding scheme, the method including providing a standard coding scheme including at least one syntax element, and modifying the at least one syntax element, thereby producing a non-standard coding scheme.

There is also provided in accordance with another preferred embodiment of the present invention a method for producing a non-standard coding scheme, the method including providing a syntax-based standard coding scheme for receiving non-coded input and producing coded output, and modifying the coded output in accordance with a non-standard syntax modification scheme.

There is also provided in accordance with another preferred embodiment of the present invention, a coding scheme produced by the above methods,

There is also provided in accordance with another preferred embodiment of the present invention a method for producing a plurality of related non-standard coding schemes, the method including providing a syntax-based standard coding scheme for receiving non-coded input and producing coded output, and performing the following a plurality of times: modifying the coded output in accordance with a non-standard syntax modification scheme, thereby producing a plurality of related non-standard coding schemes.

Further in accordance with a preferred embodiment of the present invention, for at least a first non-standard coding scheme and a second non-standard coding scheme of the plurality of related non-standard coding schemes, the first non-standard coding scheme is different from the second non-standard coding scheme.

Still further in accordance with a preferred embodiment of the present invention, for any first selected non-standard coding scheme and second selected non-standard coding scheme of the plurality of related non-standard coding schemes, the first selected non-standard coding scheme is different from the second selected non-standard coding scheme.

Additionally in accordance with a preferred embodiment of the present invention the modifying the coded output includes choosing a coded output modification.

Moreover in accordance with a preferred embodiment of the present invention the choosing includes one of the following: pseudo-randomly choosing a coded output modification, and randomly choosing a coded output modification.

There is also provided in accordance with another preferred embodiment of the present invention a plurality of related non-standard coding schemes produced by the above methods.

There is also provided in accordance with another preferred embodiment of the present invention a method for transforming content from a standard form coded in accordance with a standard coding scheme to content in a non-standard form coded in accordance with a non-standard coding scheme, the method including providing content coded in a standard form in accordance with a standard coding scheme, the standard coding scheme including at least one syntax element, modifying the at least one syntax element, thereby producing a non-standard coding scheme, and altering the content coded in the standard form in accordance with the non-standard coding scheme, thereby producing content encoded in a non-standard form in accordance with the non-standard coding scheme.

There is also provided in accordance with another preferred embodiment of the present invention a method for transforming content from a standard form coded in accordance with a standard coding scheme to content in a non-standard form coded in accordance with a non-standard coding scheme, the method including providing content coded in a standard form in accordance with a standard coding scheme, the standard coding scheme including at least one syntax element, and altering the content coded in the standard form in accordance with a non-standard syntax modification scheme, thereby producing content encoded in a non-standard form in accordance with a non-standard coding scheme.

Further in accordance with a preferred embodiment of the present invention the altering is performed a plurality of times, thereby producing a plurality of versions of content encoded in related non-standard forms in accordance with a plurality of non-standard coding schemes.

Still further in accordance with a preferred embodiment of the present invention the altering includes choosing a coded content alteration.

Moreover in accordance with a preferred embodiment of the present invention the choosing includes one of the following: pseudo-randomly choosing a coded content alteration, and randomly choosing a coded output alteration.

There is also provided in accordance with another preferred embodiment of the present invention content encoded in a non-standard form in accordance with a non-standard coding scheme, produced by any of the above methods.

There is also provided in accordance with another preferred embodiment of the present invention a method for encoding content in a non-standard form in accordance with a non-standard coding scheme, the method including providing content in non-encoded form, providing a standard coding scheme including at least one syntax element, modifying the at least one syntax element, thereby producing a non-standard coding scheme, and encoding the content in accordance with the non-standard coding scheme, thereby producing content encoded in a non-standard form in accordance with the non-standard coding scheme.

Further in accordance with a preferred embodiment of the present invention the modifying and the encoding are each performed a plurality of times, thereby producing a plurality of versions of content encoded in related non-standard forms in accordance with a plurality of non-standard coding schemes.

Still further in accordance with a preferred embodiment of the present invention the modifying includes choosing a syntax modification.

Additionally in accordance with a preferred embodiment of the present invention the choosing includes one of the following: pseudo-randomly choosing a syntax modification, and randomly choosing a syntax modification.

Moreover in accordance with a preferred embodiment of the present invention the method also includes providing a decoder for decoding the content encoded in the non-standard form.

Further in accordance with a preferred embodiment of the present invention the method also includes decoding the content encoded in the non-standard form.

Still further in accordance with a preferred embodiment of the present invention the method also includes scrambling the content coded in the non-standard form.

Additionally in accordance with a preferred embodiment of the present invention the method also includes providing a descrambler for descrambling the content coded in the non-standard form.

Moreover in accordance with a preferred embodiment of the present invention the method also includes descrambling the content coded in the non-standard form.

Further in accordance with various preferred embodiments of the present invention the standard coding scheme includes one of the following: MPEG-1, MPEG-2, MPEG-4, and H.263.

Still further in accordance with various preferred embodiments of the present invention the standard coding scheme includes one of the following: the Windows Media coding scheme, and the Real Networks coding scheme.

There is also provided in accordance with another preferred embodiment of the present invention non-standard coding scheme encoding apparatus including a syntax-based standard coding scheme encoder for receiving non-coded input and producing coded output, and a syntax modifier for modifying the coded output in accordance with a non-standard syntax modification scheme.

Further in accordance with a preferred embodiment of the present invention the syntax modifier is operative to modify the coded output in accordance with a plurality of related non-standard syntax modification schemes to produce a plurality of non-standard coded outputs.

There is also provided in accordance with another preferred embodiment of the present invention apparatus for producing a plurality of related non-standard coding schemes, the apparatus including a syntax-based standard encoder for receiving non-coded input and producing coded output, and an output modifier for performing the following a plurality of times: modifying the coded output in accordance with a non-standard syntax modification scheme, thereby producing a plurality of related non-standard coding schemes.

There is also provided in accordance with another preferred embodiment of the present invention apparatus for transforming content from a standard form coded in accordance with a standard coding scheme including at least one syntax element to content in a non-standard form coded in accordance lo with a non-standard coding scheme, the apparatus including a syntax modifier for modifying the at least one syntax element, thereby producing a non-standard coding scheme, and a content alteration device for altering the content coded in the standard form in accordance with the non-standard coding scheme, thereby producing content encoded in a non-standard form in accordance with the non-standard coding scheme.

There is also provided in accordance with another preferred embodiment of the present invention apparatus for transforming content from a standard form coded in accordance with a standard coding scheme including at least one syntax element to content in a non-standard form coded in accordance with a non-standard coding scheme, the apparatus including content alteration device for altering the content coded in the standard form in accordance with a non-standard syntax modification scheme, thereby producing content encoded in a non-standard form in accordance with a non-standard coding scheme.

There is also provided in accordance with another preferred embodiment of the present invention apparatus for encoding non-encoded content in a non-standard form in accordance with a non-standard coding scheme based on a standard coding scheme including at least one syntax element, the apparatus including a syntax modifier for modifying the at least one syntax element, thereby producing a non-standard coding scheme, and a content encoder for encoding the content in accordance with the non-standard coding scheme, thereby producing content encoded in a non-standard form in accordance with the non-standard coding scheme.

### BRIEF DESCRIPTION OF THE DRAWINGS

The present invention will be understood and appreciated more fully from the following detailed description, taken in conjunction with the drawings in which:

5 FIG. 1 is a simplified block diagram illustration of a system for distributing valuable multimedia content in accordance with the prior art;

FIG. 2 is a simplified block diagram illustration of a system for distributing valuable multimedia content, constructed and operative in accordance with a preferred embodiment of the present invention;

FIG. 3 is a simplified block diagram illustration of a system for distributing valuable multimedia content, constructed and operative in accordance with an alternative preferred embodiment of the present invention; and

FIGS. 4-9 are simplified flowchart illustrations of alternative preferred methods of operation of the present invention, in accordance with preferred embodiments thereof.

### DETAILED DESCRIPTION OF A PREFERRED EMBODIMENT

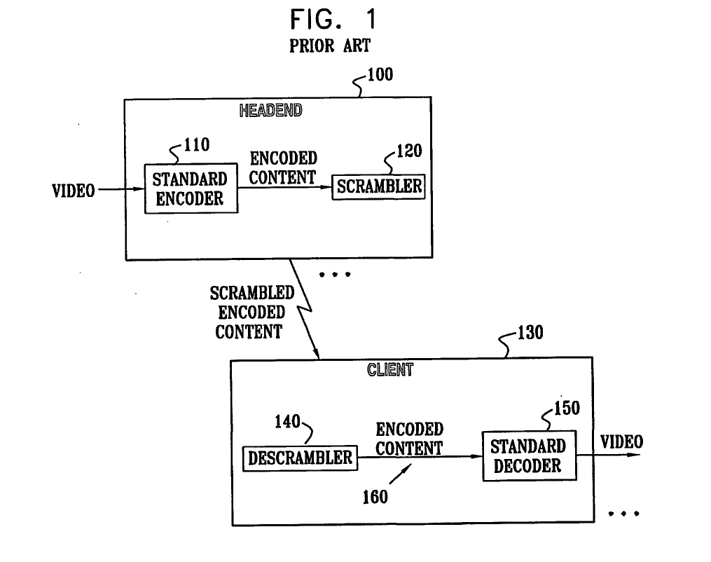

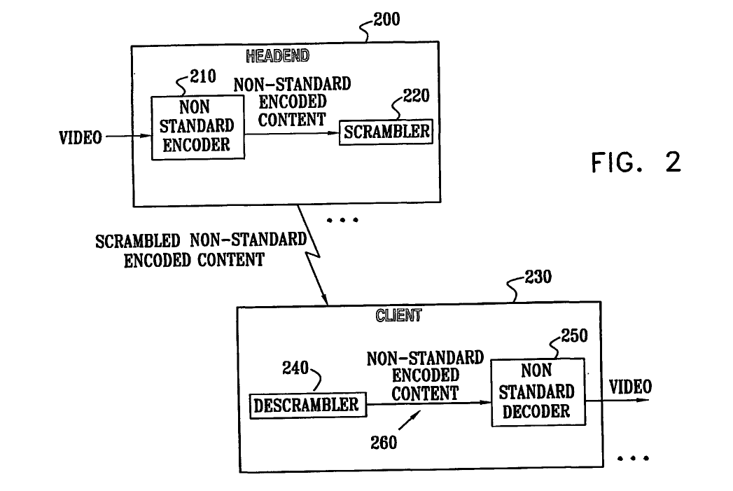

Reference is now made to FIG. 2, which is a simplified block diagram illustration of a system for distributing valuable multimedia content, constructed and operative in accordance with a preferred embodiment of the present invention. The elements of the system of FIG. 2 may be implemented in any appropriate combination of hardware and software, as is well known in the art.

The system of FIG. 2 is shown as operating on video content, it being appreciated that any appropriate type of content may be used.

The system of FIG. 2 preferably comprises a distribution headend 200. The distribution headend 200 comprises a non-standard encoder 210.

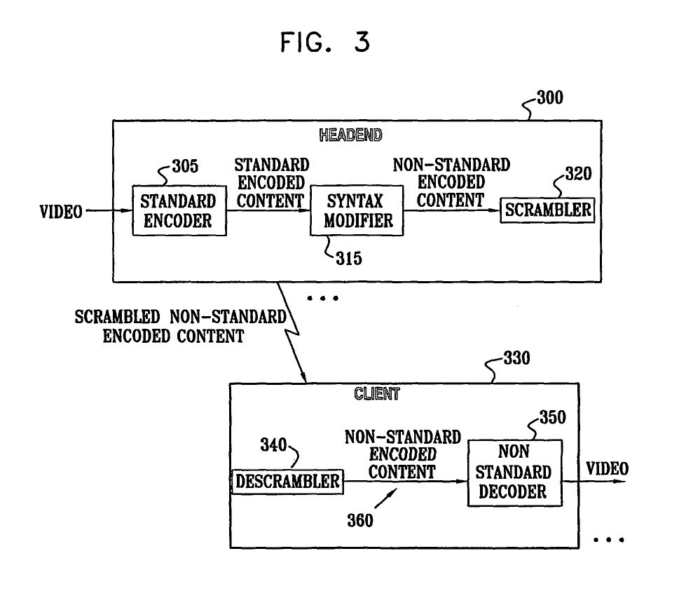

The non-standard encoder 210 is operative to perform functions similar to those of a standard encoder, such as the standard encoder 110 of FIG. 1, except that the encoding performed by the non-standard encoder 210 is non-standard. For example, the non-standard encoder 210 may use basic encoder/decoder algorithms which are different from those used by any standard decoder. Examples of basic encoder/decoder algorithms, well known in the art, include algorithms for handling of DCT, intensity/color information, and so forth. It is appreciated that the “non-standardness” of the encoding performed by the non-standard encoder 210 may take any of a variety of forms; other examples are discussed in more detail below with reference to FIG. 3.

The distribution headend 200 also preferably comprises a scrambler 220, which may comprise any appropriate scrambler well-known in the art, and which may be similar to the scrambler 120 of FIG. 1, described above.

The system of FIG. 2 also preferably comprises a plurality or large multiplicity of clients; for the sake of simplicity of description and without limiting the generality of the foregoing, a single client 230 is shown in FIG. 2.

The client 230 preferably comprises a descrambler 240, which may comprise any appropriate descrambler well-known in the art and compatible with the scrambler 220, in that the descrambler 240 is capable of descrambling scrambled encoded content produced by the scrambler 220. It is appreciated that any appropriate scrambling and descrambling mechanism may be used, and that the descrambler 240 may be similar to the descrambler 140 of FIG. 1.

The client 230 also preferably comprises a non-standard decoder 250, operative to received non-standard encoded content produced by the descrambler 240 and to decode the non-standard encoded content, thereby producing content suitable for rendering or similar use.

The term “render” is used, in all its grammatical forms, throughout the present specification and claims to refer to any appropriate mechanism or method of making content palpable to one or more of the senses. In particular and without limiting the generality of the foregoing, “render” refers not only to display of video content but also to playback of audio content.

The operation of the system of FIG. 2 is now briefly described.

Content, such as video content, is encoded in accordance with a non-standard coding scheme by the non-standard encoder 210. Non-standard encoded content produced by the non-standard encoder 210 is received as input by the scrambler 220, which produces scrambled non-standard encoded content.

The scrambled non-standard encoded content is sent, via any appropriate transmission apparatus (not shown) to the client 230. The received scrambled non-standard encoded content is input to and descrambled by the descrambler 240, producing non-standard encoded content.

It is appreciated, as described above with reference to FIG. 1, that the client 230 preferably includes an appropriate rights management subsystem (not shown), such as a rights management subsystem as is well known in the art, for determining whether the client 230 has rights to render the content, and that the client 230 will preferably be prevented from rendering the content if the client 230 has no rights therefor.

The non-standard encoded content produced by the descrambler 240 is input to the non-standard decoder 250, which produces non-encoded content, such as video, for rendering.

It is appreciated that a potential hacker of the system of FIG. 2 who attempts to steal content at a point indicated by reference number 260 will receive content which comprises non-standard encoded content. The hacker will need to be able to reverse engineer a non-standard decoder functioning similarly to the non-standard decoder 250 in order to make use of the stolen content.

To further discourage theft, it is appreciated that it is would be desirable to vary the non-standard decoder 250 for each content item and/or for each user. In other words, if there are c content items and u users, there may potentially be up to c times u different non-standard decoders. It is appreciated that in order to have a different non-standard decoder 250 for each user, it is sufficient to produce a different non-standard decoder 250 for each client 230; in order to have a different non-standard decoder for each content item, it is necessary to distribute different non-standard decoders 250 for different content items.

If a different non-standard coding scheme is desired for different content and/or users a plurality or large multiplicity of different non-standard encoders 210 will be required at the headend 200. The development of many individual non-standard encoders 210 for such a scenario is believed to be complex and likely to be prohibitively difficult and I or expensive; this is especially believed to be so if the basic encoder/decoder algorithms, such as DCT, intensity/color information handling, motion handling and so forth, as described above, are modified from one non-standard encoder 210 to another non-standard encoder 210.

By contrast, production of non-standard coding schemes whose primitives are identical to the standard schemes, but whose syntax is non-standard, is believed to be a much more feasible task.

It is well known in the art that the syntax of digital compression schemes is tightly defined in standards to enable the products of different manufacturers to inter-operate. One of the design goals of the syntax is to produce a bit stream that efficiently represents the underlying data of the coding scheme. Different syntactic fields within the bit stream are often represented in different ways. Some fields may be represented by fixed length codes and some by variable length codes, as described below.

It should be noted that the standard coding schemes were designed with hardware implementations in mind. Such an implementation assumes that the complete coding scheme—including syntax—is determined by the standard-defining documents. In some preferred implementations of the present invention, at least the syntax interpretation carried out by a non-standard decoder is preferably carried out by one or more changeable elements, typically implemented in software or firmware, that may be delivered in conjunction with the coded content.

Fixed length codes are generally the simplest representation of a given syntactic field. In digital compression schemes a field could represent a simple number value, or something more complicated. For example, in MPEG-2 video, an eight bit fixed length field is used for the start code value. This value profoundly affects the interpretation of the subsequent bit stream. For example, the start code value of hexadecimal 00 corresponds to a picture_start_code with the subsequent bits interpreted as a Picture Header. The start code value of hexadecimal B3 corresponds to the sequence_header_code with the subsequent bits interpreted as a Sequence Header.

The syntax of such a bit stream could be altered by assigning different, non-standard values to different start codes. For example, and without limiting the generality of the foregoing, the hexadecimal value 00 could be assigned to sequence_header_code, while the hexadecimal value B3 could be assigned to picture_start_code. The effect of such an approach would be to render viewing and/or other rendering of the bit stream on a standard MPEG-2 decoder impossible.

In accordance with a preferred embodiment of the present invention, syntactic translation for fixed length codes could be performed using static look up tables. Alternatively, more complicated approaches might use algorithmic state machines to create non-static syntactic translations, allowing optimization for reverse-engineering resistant implementations in addition to the more standard criteria of code efficiency.

Within digital compression schemes variable length codes (VLCs) are often used to efficiently represent data. Generally, it is well known in the art that the probabilities of occurrence for different symbols in an alphabet, or of different values in a data set, are different. For example, and without limiting the generality of the foregoing, when representing the English language using the western alphabet, the letter “e” is much more common than the letter “q”. For efficient coding of the English language/western alphabet, shorter code words are preferably used to represent the letter ‘e’ than the letter ‘q’. Morse code is a well known example of the application of this technique and of the use of VLCs in general. A general term used in the art for the efficient coding of a data set based on its statistics is “entropy coding”.

For efficient binary coding of data sets Huffman encoding, which is well known in the art, is often used. In many standard digital compression schemes such static Huffman codes (or similar codes) are specified in the form of a look up table for a given data set.

Within standard digital compression schemes VLCs are often specified as fixed lookup tables for a given data set. The standard VLCs are generic to all content and the statistics used for them will be those gathered from a representative set of content; such standard VLCs implement static Huffman codes or similar codes.

Changing the syntax of a VLC code is a more complex process than changing a fixed length code. Since the VLC table is generally optimized for representing the given data set efficiently, randomly changing the table is likely to result in an increased quantity of data to be sent. For example, in Morse code swapping the symbol for “q” with that for “e” would result in longer messages.

Without limiting the generality of the present invention, the following is presented as an example of one preferred implementation for changing the syntax of a VLC for a given data set:

For each code word length:

1. Group together all variable length code words of the same length to produce a grouped subset.

2. Treat the grouped subset as a set of fixed length codes and apply the syntactic translation described previously for fixed length codes.

The suggested implementation would not alter the amount of binary data required to represent the content.

An alternative preferred implementation could actually improve compression efficiency by reducing the amount of data to represent the content. As previously described, the standard VLC tables are generic to all possible content; therefore, it may be possible to optimize the standard VLC tables further for specific instances of coded content. For example, it is possible that, in some cases, not all possible values of a given set of VLC tables will be used in the s compression of given piece of content. Furthermore, the usage statistics of the values in the data set are likely to be different to the generic statistics used to define the standard VLC. Hence it is possible to utilize statistics gathered for a specific piece of content to generate a new VLC table that is optimized for that specific piece of content. For large pieces of content, such as video, it is possible that this approach could be applied to the compressed content as a whole, or to smaller batches such as, for example, batches each comprising a few seconds of video.

Other entropy coding techniques, in addition to VLC tables, are known in the art. A further example of an entropy technique is arithmetic coding, which is described, for example, in the following reference:

I. H. Witten, R. M. Neal and J. G. Cleary, “Arithmetic coding for data compression”, pp. 520-540, Communications of the ACM, v30n6, June 1987.

Approaches can be adaptive, learning the statistics for the data that is being coded. Such schemes will produce different bit streams, and thus a different syntax, based on their initialization parameters. Modification of the initialization parameters is believed to be possible, thus modifying the syntax of the bit stream and providing an alternative implementation.

It is appreciated that the examples given above are not meant to limit the generality of the present invention. The above examples have described various alternatives for carrying out syntactic translation without adversely effecting the size of the coded content As noted above, changes to the syntax need not be static; algorithmic state machines can be applied to create dynamic changes. As a simple example consider a single bit used to represent the sign of a number. A simple two-state state machine can be envisaged by which a ‘1’ is used to represent a positive sign and ‘0’ a negative sign if the last sign bit received were positive, with the inverse representation if the last sign bit received were negative. The state machine could be reset to a known starting condition at the start of a known synchronization event, such as the beginning of a frame in a video compression scheme.

It is appreciated that other methods for changing the syntax may also be used; for example the order of the coded primitives contained in the stream could be changed. For example and without limiting the generality of the foregoing, in a case of an MPEG-2 macroblock where the standard order “Y U V” is normally used for components defining luminance, chrominance-1, and chrominance-2, an appropriate syntax change might comprise using the non-standard order “U Y V”.

It is further appreciated that other methods, such as methods employing content transformations, may be used. For example and without limiting the generality of the foregoing, a part of a macroblock may be sent in altered form, such as one or more of the following: complemented; negated; XOR with a fixed constant; XOR with a changeable constant. Persons skilled in the art will appreciate that many similar transformations and combinations thereof may be used and are contemplated as part of the present invention. It is further appreciated that, within the context of the present invention, content transformations of the type described are comprised in the more general concept of syntax modification.

It is appreciated that flexible approaches, such as that described above for improving the compression efficiency using VLCs, may be preferred for stored content where processing can be performed off line. For live content the possible approaches are believed to be constrained to those that do not require a significant data buffer that would delay the delivery of the content. For example, for live content, it may be preferred to not perform the dynamic analysis required for VLC optimization over short periods of time within a specific piece of content; this example is not meant to be limiting, and it is appreciated that skilled persons of the art will appreciate that there may be other appropriate examples.

It is also appreciated that variations and combinations of syntax modifications could be generated in a random or pseudo-random fashion, thus producing a very large number of possible alternative non-standard coding schemes.

Reference is now made to FIG. 3, which is a simplified block diagram illustration of a system for distributing valuable multimedia content, constructed and operative in accordance with an alternative preferred embodiment of the present invention.

The system of FIG. 3 is similar to the system of FIG. 2. In FIG. 3, a headend 300 comprises, instead of the non-standard encoder 210 of FIG. 2, a standard encoder 305 and a syntax modifier 315. The syntax modifier 315 may be implemented in any appropriate combination of hardware and software.

A client 330, comprising a descrambler 340 and a non-standard decoder 350, may be similar to the client 230, descrambler 240, and non-standard decoder 250 of FIG. 2, respectively.

The operation of the system of FIG. 3 is now briefly described.

Content is first coded in a standard format by the standard encoder 305. Standard encoded content produced by the standard encoder 305 is then post-processed by the syntax modifier 315 to change at least one syntax element of the syntax of the standard encoded content, thus producing non-standard encoded content, encoded in a non-standard form.

In the authorized client 330, similarly to the client 230 of FIG. 2, the non-standard decoder 330 is required to view and/or render the content. Thus, within the client 330 the content is never available in a form that is easily distributed for viewing on standard decoders; for example, a hacker attempting to steal the content at a point indicated by reference number 360 will be faced with the same difficulties described above with reference to FIG. 2 and reference number 260.

The preferred embodiment of FIG. 3 is believed to have several significant advantages over the preferred embodiment of FIG. 2:

1. It is believed to be far easier to generate a non-standard decoder 350, such as an obfuscated or randomized decoder, than it would be if the basic algorithms as described above were to vary.

2. Since there are typically many syntax elements in the syntax of standard encoded content, the number of variations on the decoding scheme that may be developed is very large. Hence, a separate scrambling/descrambling step may not be required in order to achieve the desired security; in such a case, the scrambler 320 and descrambler 340 may be optional.

Ideally, as described above, the changed syntax is different at least for every piece of content, such that a new non-standard decoder 350 is required for each content item; optionally, the changed syntax may also be different for each user, also as described above.

The preferred embodiment of FIG. 3 is believed to be preferred because a full unique encoding engine does not need to be developed for each variation in the syntax. The many specialized developments of third party encoding engines, such as real time motion estimation for video, can be leveraged. Furthermore, it is appreciated that the approach used in the preferred embodiment of FIG. 3 can be applied to existing compressed content, or to content compressed in real-time by specialized high-speed hardware

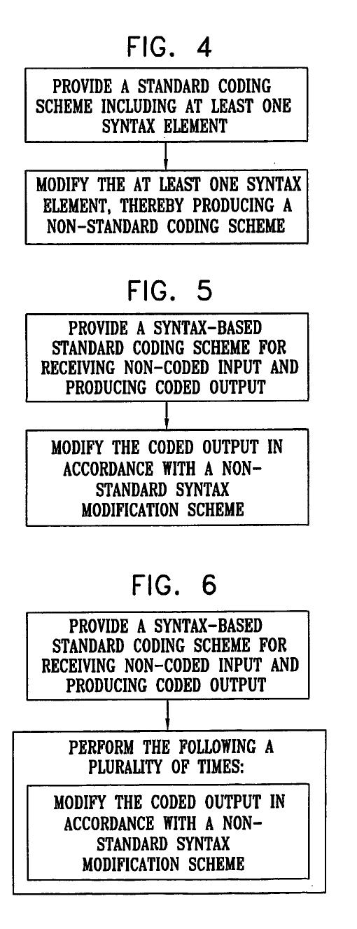

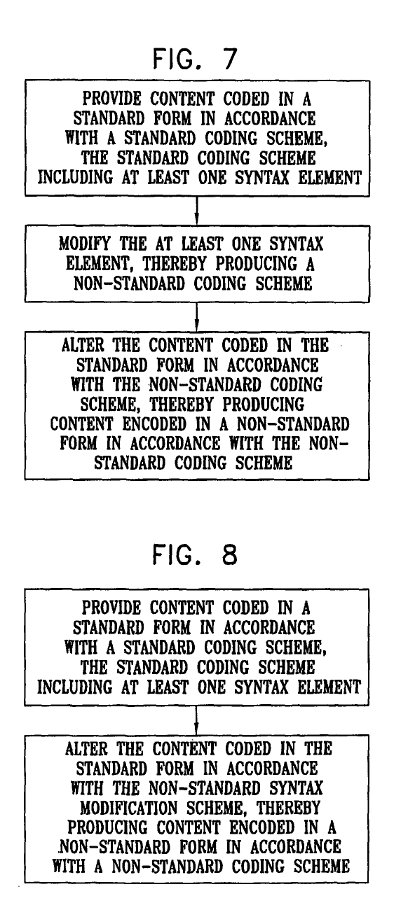

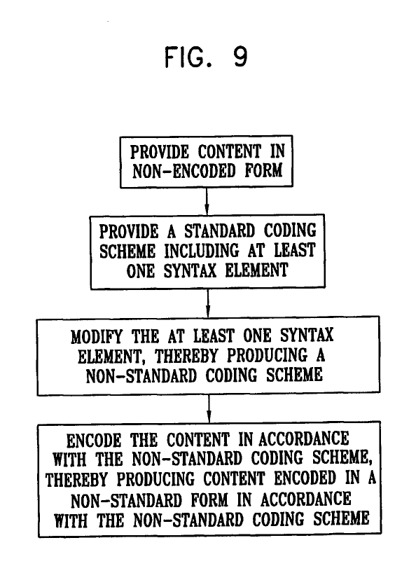

Reference is now made to FIGS. 4-9, which are simplified flowchart illustrations of alternative preferred methods of operation of the present invention, in accordance with preferred embodiments thereof. The methods of FIGS. 4-9 are believed to be self-explanatory with reference to the above discussion of FIGS. 2 and 3.

It is appreciated that various features of the invention which are, for clarity, described in the contexts of separate embodiments may also be provided in combination in a single embodiment. Conversely, various features of the invention which are, for brevity, described in the context of a single embodiment may also be provided separately or in any suitable subcombination.

It will be appreciated by persons skilled in the art that the present invention is not limited by what has been particularly shown and described hereinabove. Rather the scope of the invention is defined only by the claims which follow:

What is claimed is:

1. A method for producing a non-standard coding scheme, the method comprising:
providing a standard coding scheme including at least one syntax element; and
modifying the at least one syntax element, thereby producing a non-standard coding scheme.

2. A method for producing a non-standard coding scheme, the method comprising:
providing a syntax-based standard coding scheme for receiving non-coded input and producing coded output; and
modifying the coded output in accordance with a non-standard syntax modification scheme.

3. A coding scheme produced by the method of claim 1 or claim 2.

4. A method for producing a plurality of related non-standard coding schemes, the method comprising:
providing a syntax-based standard coding scheme for receiving non-coded input and producing coded output; and
performing the following a plurality of times:
modifying the coded output in accordance with a non-standard syntax modification scheme,
thereby producing a plurality of related non-standard coding schemes.

5. The method according to claim 4 and wherein, for at least a first non-standard coding scheme and a second non-standard coding scheme of the plurality of related non-standard coding schemes, the first non-standard coding scheme is different from the second non-standard coding scheme.

6. The method according to claim 5 and wherein, for any first selected non-standard coding scheme and second selected non-standard coding scheme of the plurality of related non-standard coding schemes, the first selected non-standard coding scheme is different from the second selected non-standard coding scheme.

7. The method according to any of claims 4-6 and wherein the modifying the coded output comprises choosing a coded output modification.

8. The method according to claim 7 and wherein the choosing comprises one of the following: pseudo-randomly choosing a coded output modification; and randomly choosing a coded output modification.

9. A plurality of related non-standard coding schemes produced by the method of any of claims 4-8.

10. A method for transforming content from a standard form coded in accordance with a standard coding scheme to content in a non-standard form coded in accordance with a non-standard coding scheme, the method comprising:
providing content coded in a standard form in accordance with a standard coding scheme, the standard coding scheme including at least one syntax element;
modifying the at least one syntax element, thereby producing a non-standard coding scheme; and
altering the content coded in the standard form in accordance with the non-standard coding scheme, thereby producing content encoded in a non-standard form in accordance with the non-standard coding scheme.

11. A method for transforming content from a standard form coded in accordance with a standard coding scheme to content in a non-standard form coded in accordance with a non-standard coding scheme, the method comprising:
providing content coded in a standard form in accordance with a standard coding scheme, the standard coding scheme including at least one syntax element; and
altering the content coded in the standard form in accordance with a non-standard syntax modification scheme, thereby producing content encoded in a non-standard form in accordance with a non-standard coding scheme.

12. The method according to claim 11 and wherein the altering is performed a plurality of times, thereby producing a plurality of versions of content encoded in related non-standard forms in accordance with a plurality of non-standard coding schemes.

13. The method according to any of claims 10-12 and wherein the altering comprises choosing a coded content alteration.

14. The method according to claim 13 and wherein the choosing comprises one of the following: pseudo-randomly choosing a coded content alteration; and randomly choosing a coded output alteration.

15. Content encoded in a non-standard form in accordance with a non-standard coding scheme, produced by the method of any of claims 10-14.

16. A method for encoding content in a non-standard form in accordance with a non-standard coding scheme, the method comprising:
providing content in non-encoded form;
providing a standard coding scheme including at least one syntax element;
modifying the at least one syntax element, thereby producing a non-standard coding scheme; and
encoding the content in accordance with the non-standard coding scheme, thereby producing content encoded in a non-standard form in accordance with the non-standard coding scheme.

17. The method according to claim 16 and wherein the modifying and the encoding are each performed a plurality of times, thereby producing a plurality of versions of content encoded in related non-standard forms in accordance with a plurality of non-standard coding schemes.

18. The method according to claim 16 or claim 17 and wherein the modifying comprises choosing a syntax modification.

19. The method according to claim 18 and wherein the choosing comprises one of the following: pseudo-randomly choosing a syntax modification; and randomly choosing a syntax modification.

20. The method according to any of claims 10-19 and also comprising:
providing a decoder for decoding the content encoded in the non-standard form.

21. The method according to any of claims 10-20 and also comprising:
decoding the content encoded in the non-standard form.

22. The method according to any of claims 10-21 and also comprising:
scrambling the content coded in the non-standard form.

23. The method according to claim 22 and also comprising:
providing a descrambler for descrambling the content coded in the non-standard form.

24. The method according to claim 22 or claim 23 and also comprising:
descrambling the content coded in the non-standard form.

25. The method according to any of the above claims and wherein the standard coding scheme comprises one of the following: MPEG-1; MPEG-2; MPEG4; and H.263.

26. The method according to any of the above claims and wherein the standard coding scheme comprises one of the following: the Windows Media coding scheme; and the Real Networks coding scheme.

27. Non-standard coding scheme encoding apparatus comprising:
a syntax-based standard coding scheme encoder for receiving non-coded input and producing coded output; and
a syntax modifier for modifying the coded output in accordance with a non-standard syntax modification scheme.

28. Apparatus according to claim 27 and wherein the syntax modifier is operative to modify the coded output in accordance with a plurality of related non-standard syntax modification schemes to produce a plurality of non-standard coded outputs.

29. Apparatus for producing a plurality of related non-standard coding schemes, the apparatus comprising:
a syntax-based standard encoder for receiving non-coded input and producing coded output; and
an output modifier for performing the following a plurality of times:
modifying the coded output in accordance with a non-standard syntax modification scheme,
thereby producing a plurality of related non-standard coding schemes.

30. Apparatus for transforming content from a standard form coded in accordance with a standard coding scheme including at least one syntax element to content in a non-standard form coded in accordance with a non-standard coding scheme, the apparatus comprising:
a syntax modifier for modifying the at least one syntax element, thereby producing a non-standard coding scheme; and
a content alteration device for altering the content coded in the standard form in accordance with the non-standard coding scheme, thereby producing content encoded in a non-standard form in accordance with the non-standard coding scheme.

31. Apparatus for transforming content from a standard form coded in accordance with a standard coding scheme including at least one syntax element to content in a non-standard form coded in accordance with a non-standard coding scheme, the apparatus comprising:
a content alteration device for altering the content coded in the standard form in accordance with a non-standard syntax modification scheme, thereby producing content encoded in a non-standard form in accordance with a non-standard coding scheme.

32. Apparatus for encoding non-encoded content in a non-standard form in accordance with a non-standard coding scheme based on a standard coding scheme including at least one syntax element, the apparatus comprising:
a syntax modifier for modifying the at least one syntax element, thereby producing a non-standard coding scheme; and
a content encoder for encoding the content in accordance with the non-standard coding scheme, thereby producing content encoded in a non-standard form in accordance with the non-standard coding scheme.
